(19) United States
(12) Patent Application Publication
(10) Pub. No.: US 2015/0237510 A1
(43) Pub. Date: Aug. 20, 2015

(54) MICRO-STEERING BEAMS IN MULTI-BEAM COMMUNICATIONS SYSTEMS

(71) Applicant: Magnolia Broadband Inc., Englewood, NJ (US)

(72) Inventors: Kenneth KLUDT, San Jose, CA (US); Haim HAREL, New York, NY (US); Stuart S. JEFFERY, Los Altos, CA (US)

(73) Assignee: Magnolia Broadband Inc., Englewood, NJ (US)

(21) Appl. No.: 14/181,844

(22) Filed: Feb. 17, 2014

(51) Int. Cl. H04W 16/28

(52) U.S. Cl. CPC H04W 16/28

(57) ABSTRACT

A system and method may provide minor pattern adjustment to a fixed beam system using signal coupling. When equipment is found to be operating in adjacent overlapping beams the beams may be adjusted in terms of amplitude and/or phase in order to provide improved signal quality to supported UEs. This may include constructively combining signals from adjacent beams for a supported UE or destructively combining signals from adjacent beams for a non-supported UE in order to improve the SINR for a supported UE.

### FIELD OF THE INVENTION

The present invention relates generally to the field of operating access points in wireless communications networks. Examples of such networks include WiFi networks and cellular networks.

### BACKGROUND

Prior to setting forth a short discussion of the related art, it may be helpful to set forth definitions of certain terms that will be used hereinafter.

UE stands for User Equipment and represents for example a client unit which communicates with a base station or an Access Point.

The term AP stands for Access-Point and represents for example a Wi-Fi base station.

The term “MIMO” as used within this application, is defined as the use of multiple antennas at both the transmitter and receiver to improve communication performance.

The term “SISO” as used within this application is defined as the use of single antennas at both transmitter and receiver.

“Channel estimation” is used herein to refer to estimation of channel state information which describes properties of a communication link such as signal to noise ratio “SNR” and signal to interference plus noise ratio “SINR”. Channel estimation may be performed by user equipment and base station or APs as well as other components operating in a communications system.

The term “beamforming” sometimes referred to as “spatial filtering” as used herein, is a signal processing technique used in antenna arrays for directional signal transmission or reception. This is achieved by combining elements in the array in such a way that signals at particular angles experience constructive interference while others experience destructive interference. Beamforming can be used at both transmission and reception. Beamforming is also more generally referred to in the following as coupling energy or power (carried by signals) transmitted or received by at least two antennas.

The term “multi-beam AP” or “MBAP” is usually used in the context of a MBAP system and refers to a system comprising multiple base stations/APs connected to an antenna array producing multiple beams.

The term “beamformer” as used within this application refers to RF and/or digital circuitry that may implement beamforming methods and may incorporate signal combiners, phase shifters, delays and, in some cases, amplifiers and/or attenuators to adjust the weights of signals presented to and from each transceiver in the area covered by an antenna array. Digital beamformers may be implemented in digital circuitry such as a digital signal processor (DSP), field-programmable gate array (FPGA), microprocessor or the central processing unit (CPU) of a computer to set the weights (phases and amplitudes) of the above signals. Various techniques are used to implement beamforming including Butler matrix, Blass Matrix and Rotman Lens. In general, most approaches attempt to provide simultaneous coverage within a sector using multiple beams. It will be appreciated that a beamformer may be implemented in software or hardware or a combination of software and hardware.

In the following the term user equipment (UE) is intended to represent any equipment that is intended to be supported by a wireless communications network.

Unlike the situation with time division duplexing “TDD” cellular air-protocols, co-located WiFi APs may interfere with each other unless sufficient isolation (e.g., in excess of 125 dB) is provided between the transmitting of one and receiving of the other. This may be addressed by physically separating the antenna arrays for transmit and receive. Another limitation is reflected in that multi-beam antennas offer limited separation of the coverage of one beam from the others. The following discusses the impacts of this performance limitation and presents approaches to mitigate its effect.

### SUMMARY

Some embodiments of the present invention include a method of operating two or more APs in a wireless communications network wherein a system of two or more APs are supported by an antenna array that provides multiple beams having overlapping coverage. Embodiments may comprise identifying equipment which is transmitting or receiving signals in at least two overlapping beams of the multiple beams having overlapping coverage; and coupling signals received from or generating signals for transmission to identified equipment in said at least two beams using a common frequency resource. According to some embodiments, the coupling may be done in order to perform at least one of increasing signal quality for identified equipment that is supported by the communications network; and reducing signal strength for identified equipment that is not supported by the communications network.

Other embodiments of this invention include a system for use in a wireless communications network. Embodiments may comprise two or more wireless APs associated with multiple beams having overlapping coverage, two or more beamformers configured to control an antenna array to create the multiple beams, and one or more processors configured to control one or both of amplitude and phase of signals applied by the APs to the beamformers or applied from the beamformers to the APs. Embodiments may be configured to operate at least some of the beams having overlapping coverage to use at least a common frequency resource; and couple signals received from or generate signals to be transmitted to equipment in at least two beams using a common frequency resource. This may be done in order to increase signal quality for equipment that is supported by the communications network or reduce signal strength for equipment that is not supported by the communications network, or both.

According to some embodiments of the invention the coupling or generating may comprise comprises adjusting one or both of amplitude and phase of the signal voltage received from or to be coupled at the equipment. According to some embodiments of the invention the adjusting may comprise determining a coupling function including one or more weighting factors for amplitude for one of the signal voltages from at least one of the at least two beams to be coupled to the signal voltages of another of the at least two beams.

According to some embodiments of the invention the coupling may be performed to increase signal quality for identified equipment. Such coupling may further comprise using channel estimation to determine one or both of:

or more weighting factors for the coupling of the signals in the at least two beams; and
the relative phases of signals to be coupled in the at least two beams.

According to some embodiments of the invention, channel estimation may be performed on received signals in said at least two overlapping beams and may further comprise using one or both of weighting factors and relative phases to determine one or both of relative amplitudes and relative phases of signals for transmission to identified equipment.

According to some embodiments of the invention, the identifying may identify equipment that is supported by the network transmitting or receiving in a main beam and at least one overlapping adjacent beam of said multiple beams having overlapping coverage, and equipment that is not supported by the network transmitting or receiving in the main beam and at least one different overlapping adjacent beam of said multiple beams having overlapping coverage. The coupling may then comprise coupling signals from the supported equipment in the adjacent beam(s) and the main beam and simultaneously coupling signals from equipment that is not supported in the different adjacent beam(s) and the main beam. Embodiments may comprise determining one or more weighting factors for signals to be coupled at the not supported equipment, followed by determining one or more weighting factors for signals to be coupled at the supported equipment.

Embodiments may comprise scanning frequency resources used by the beams having overlapping coverage to analyze which equipment signals appear in which beam.

Embodiments of the invention may comprise determining whether identified equipment is a UE supported by the communications network. In some embodiments this identifying may identify a UE supported by the communications network and further comprise identifying equipment that is not supported by the communications network that is transmitting or receiving signals on a subset of the at least two beams having overlapping coverage; wherein said coupling comprises reducing the power of one or more of the beams in the subset.

According to embodiments of the invention, the coupling for equipment that is not supported by the communications network may comprise adjusting one or both of the amplitude and phase of signals in one of the at least two beams to cancel the signal from the equipment in another of the at least two beams.

According to embodiments of the invention the beams may be fixed beams. Embodiments of the invention may comprise a scanning AP configured to scan the multiple beams to determine which equipment is operating in which beam.

According to embodiments of the invention the multiple beams may operate using at least two different frequency channels. Embodiments of the invention may comprise a single block radio frequency “RF” upconverter for each antenna of the antenna array or separate RF upconverters for each channel for each antenna. Embodiments of the invention may comprise a single block radio frequency “RF” downconverter for each antenna of the antenna array or separate RF downconvertors for each channel for each antenna.

APs that may benefit from embodiments of the invention include those that use radio frequency (RF) multiple-input-multiple-output (MIMO) systems and in particular systems and methods for enhanced performance of RF MIMO systems using RF beamforming and/or digital signal processing. Embodiments of the invention also have application in single input single output (SISO) systems. Communications systems that may benefit from embodiments of the invention may use WiFi; 802.11, 802.11a, 802.11, 802.11b, 802.11g, 802-11n, 802.11ac and other further related wireless communication protocols; long term evolution (LTE); time division duplexing (TDD); time division multiple access (TDMA); code division multiple access (CDMA); synchronous CDMA (SCDMA); Wi-Max; time division long term evolution (TD-LTE); and time division SCDMA (TD-SCDMA). Systems implementing embodiments of the invention may include phased antenna arrays, receivers; portable consumer receiver devices, UEs, transmitters; beamforming; Digital Signal Processing (DSP); digital filtering; analog and digital signal cancellation and related interference mitigation.

### BRIEF DESCRIPTION OF THE DRAWINGS

For a better understanding of embodiments of the invention and in order to show how it may be implemented, references are made, purely by way of example, to the accompanying drawings in which like numerals designate corresponding elements or sections. In the accompanying drawings:

FIG. 1 is a schematic diagram of a multi-beam AP (MBAP) system according to an embodiment of the invention;

FIG. 2 is a schematic diagram of a sector coverage further divided into subsectors by the multi-beam AP system of FIG. 1 according to an embodiment of the invention;

FIG. 3 is a high level illustration of an implementation of an eight beam MBAP system according to an embodiment of the invention;

FIG. 4 is an exemplary depiction of the radiation patterns for an eight-beam antenna array according to an embodiment of the invention;

FIG. 5(a) is a functional diagram explaining micro-steering of beams on reception according to an embodiment of the invention;

FIG. 5(b) is a functional diagram explaining micro-steering of beams for transmission according to an embodiment of the invention;

FIG. 6 is a simplified block diagram for one embodiment of beam steering according to an embodiment of the invention;

FIGS. 7(a) and 7(b) are simplified block diagrams for two embodiments of a radio down converter assembly according to an embodiment of the invention;

FIGS. 8(a) and 8(b) are simplified block diagrams for two embodiments of a radio up converter assembly according to an embodiment of the invention;

FIGS. 9(a) and 9(b) are exemplary radiation patterns showing a method for micro-steering a fixed beam according to an embodiment of the invention;

FIG. 10 shows an exemplary flow showing processes according to an embodiment of the invention;

FIG. 11 shows an exemplary flow for methods according to embodiments of the invention;

FIG. 12 shows an exemplary flow illustrating in more detail a possible implementation of part of the flow of FIG. 11; and

FIG. 13 shows an exemplary flow showing operations that may be implemented instead of or in addition to some of the operations of FIG. 11.

The drawings together with the following detailed description make the embodiments of the invention apparent to those skilled in the art.

### DETAILED DESCRIPTION

It is stressed that the particulars shown are for the purpose of example and solely for discussing the preferred embodiments of the present invention, and are presented in the cause of providing what is believed to be the most useful and readily understood description of the principles and conceptual aspects of embodiments of the invention. In this regard, no attempt is made to show structural details of the embodiments of the invention in more detail than is necessary for a fundamental understanding of the invention. The description taken with the drawings makes apparent to those skilled in the art how the several forms of the invention may be embodied in practice.

Before explaining the embodiments of the invention in detail, it is to be understood that the invention is not limited in its application to the details of construction and the arrangement of the components set forth in the following descriptions or illustrated in the drawings. The invention is applicable to other embodiments and may be practiced or carried out in various ways. Also, it is to be understood that the phraseology and terminology employed herein is for the purpose of description and should not be regarded as limiting.

In an embodiment of a method for providing continuous coverage throughout a sector the coverage offered in adjacent beams of a communication network overlaps. These adjacent beams may be provided by one or more multi-beam antennas or by suitably positioned single antennas. This presents a potential for attaining an improvement in performance when adjacent beams illuminate the same area on the same frequency. The possibility exists that some UEs are located near the directions where the beams overlap. The means for offering said advantages by using the signal contained in both beams to improve the signal to and from such UEs are suggested herein. In one embodiment a scanning AP is used to investigate adjacent beams when the system is receiving a signal on a beam. The AP can then further use this information to better steer the beam more directly towards the desired UE if it is being served or away from a UE or other equipment that may be a source of interference to a UE being served.

A system is described to provide minor pattern adjustment to a fixed beam system using signal coupling. When equipment is found to be operating in adjacent overlapping beams the beams may be adjusted in terms of amplitude and/or phase in order to provide improved signal quality to supported UEs. This may comprise constructively combining signals from adjacent beams for a supported UE or destructively combining signals from adjacent beams for a non-supported UE or other equipment in order to improve the signal quality for a supported UE. Signal quality may be determined from one or more parameters including but not limited to signal to SINR, packet error rate and signal level (amplitude) e.g. as measured by received signal strength indicator “RSSI”.

As the following will show, the “equipment” mentioned in the foregoing paragraph may be a UE or some other source of signals.

It will be appreciated that an embodiment of a method may comprise determining whether identified equipment is a UE supported by the communications network. This can be achieved in some embodiments by scanning all of the beams in an MBAP system and analysing incoming signals.

The coupling of signal voltages may comprise adjusting one or both of amplitude and phase of the signal voltage applied to or received from at least one identified equipment.

Prior systems using overlapping beams have usually operated the overlapping beams, sometimes referred to in the following as adjacent beams, on different resources (usually different frequencies) to avoid interference between equipment in adjacent beams. Here it is proposed to use the same frequency in overlapping or adjacent beams on the same frequency for equipment found to be operating in two or more overlapping or adjacent beams, so as to be able to use spatial filtering for the benefit of a UE that is supported by the communications network. This can be done in several ways.

If a UE that is supported by the communications network (hereinafter “network”) is found to be transmitting and/or receiving in two or more beams having overlapping coverage (hereinafter “overlapping beams”), the signals (transmit or receive) in those overlapping beams can be used to steer a beam towards the UE so as to improve the signal quality for that UE. This might be achieved for example through improvements in the gain offered in one or both beams. This is particularly beneficial in the event that there is any kind of interference in one or more, but not all, of the beams in which the UE is transmitting. The energy from the beams can be steered away from the source of interference. At the same time the energy available to the interference source may be reduced so that it is less problematic for the UE in question, the “target” UE.

If a non-supported UE is found to be transmitting and/or receiving in two or more beams having overlapping coverage, the signals (transmit or receive) in those overlapping beams can be used to steer a beam away from the non-supported UE so as to reduce any interference that may be caused by the non-supported UE. A non-supported UE might be for example a UE operating in a different network or a cordless (e.g. non-mobile) phone. This principle is applicable not only to non-supported UEs but also other sources of interference such as microwave ovens and other appliances capable of transmitting and/or receiving within the frequency band of the beam, whether intentionally or otherwise. Such sources of interference, whether UEs or not, are referred to herein generically as “equipment”. At the same time as steering the direction of the beams away from the source of interference, more energy may be offered to or received from a target UE. The two actions of steering away from the source of interference and optionally also increasing the energy from/to the target may both result in an improvement in the signal quality offered from/to the target UE.

The adjusting of phase and/or amplitude may comprise calculating a coupling ratio for the amplitude of the signal in one of the at least two beams to be coupled to the signal in another of the at least two beams. This can be chosen by considering various metrics such as but not limited to SNR and amplitude. For the case of non-supported equipment ideally this means determining a coupling ratio for a signal in one of the at least two beams to cancel or reduce the level of the signal from the non-supported equipment in the other of the at least two beams. For the case of supported equipment as noted above the coupling ratio is calculated with a view to increasing the signal quality for the supported UE. The adjusting of amplitude may be done using the known technique of maximal ratio combining “MRC”, for example.

It should be noted that the order of the operations that comprise the embodiment of the method described above may be varied. In particular, an embodiment of the method will typically commence with a survey to determine whether there is any equipment transmitting or receiving signals. The identification of whether such equipment is supported or not may be carried out at this stage.

The embodiments to be discussed in more detail below will present a two dimensional example in which one beam is overlapped on two “sides” but it will be appreciated that the principle can be extended to any number of overlapping beams. Thus whereas an embodiment of a method is described in terms of a supported UE in the overlap region of two beams and a non-supported UE or other in one of those beams, an embodiment is applicable to any situation where one of the supported UE and the interference source is operating within multiple beams and the other is operating in a subset of those beams (including one beam). Embodiments are also applicable to any situation where one of the supported UE and the interference source is operating within multiple beams and the other is operating in an overlapping set of those beams. The particular embodiments described below do not achieve any improvement when the UE and the source of interference both operate on the same set of beams.

It will also be appreciated that embodiments may be extended to deal with multiple sources of interference.

The embodiments of the invention to be described below have been designed for multi-beam APs. For the purpose of this description an AP can be considered to be a radio transceiver capable of handling a signal from one UE, as in the case of a SISO system, or more than one signal from a UE as may appear for example in a MIMO system, or signals from more than one UE (multi-user MIMO). In these cases it is possible for one signal stream to be supported by multiple beams. However it can also be envisaged that multiple beams from different antenna arrays may overlap to enable one signal stream to be supported by multiple beams. Thus where overlapping beams are described herein this includes overlapping beams from different antenna arrays or different APs unless otherwise stated.

The expression “multiple beams having overlapping coverage” encompasses a beam arrangement in which the direction of coverage of one of the beams is overlapped by that of at least one other beam. Some such beams, e.g. at the outer regions of the area covered by the beams, may be overlapped by only one other beam.

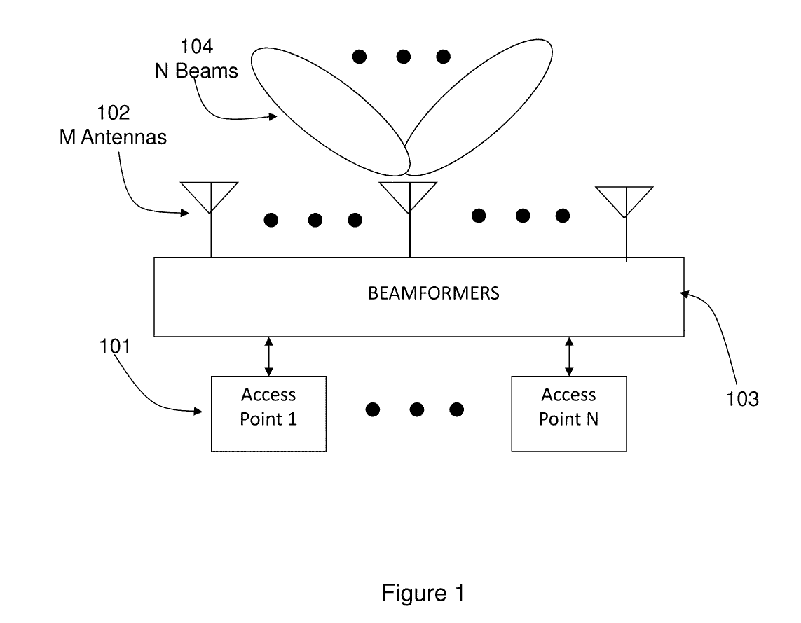

FIG. 1 shows for the purpose of explanation multiple APs 101 associated with an array of beamformers 103 and antennas 102. The beamformers 103 each comprise circuitry and/or software controlling one or more of antennas 102 to create a number of beams 104. Each “beam” defines the direction of the antenna for transmission and reception of signals and thus defines a distinct spatial region. In the system of FIG. 1, multiple-beam or single-beam antennas may be used. The combination of APs 101, beamformers 103 and antennas 102 forms a multi-beam AP system, which may operate using phased array technology. In the system shown in FIG. 1 M antennas are used to simultaneously create N beams that support N APs 101. In other words, in this embodiment there is a one to one correspondence between beams and APs. M and N are integers. In this embodiment M is greater than or equal to N. Each AP is configured to process signals received and transmitted within its corresponding beam. In embodiments of the invention each beam is created by one or more of the antennas. For each beam to be created by multiple antennas there may be more antennas than beams in which case N will be greater than M.

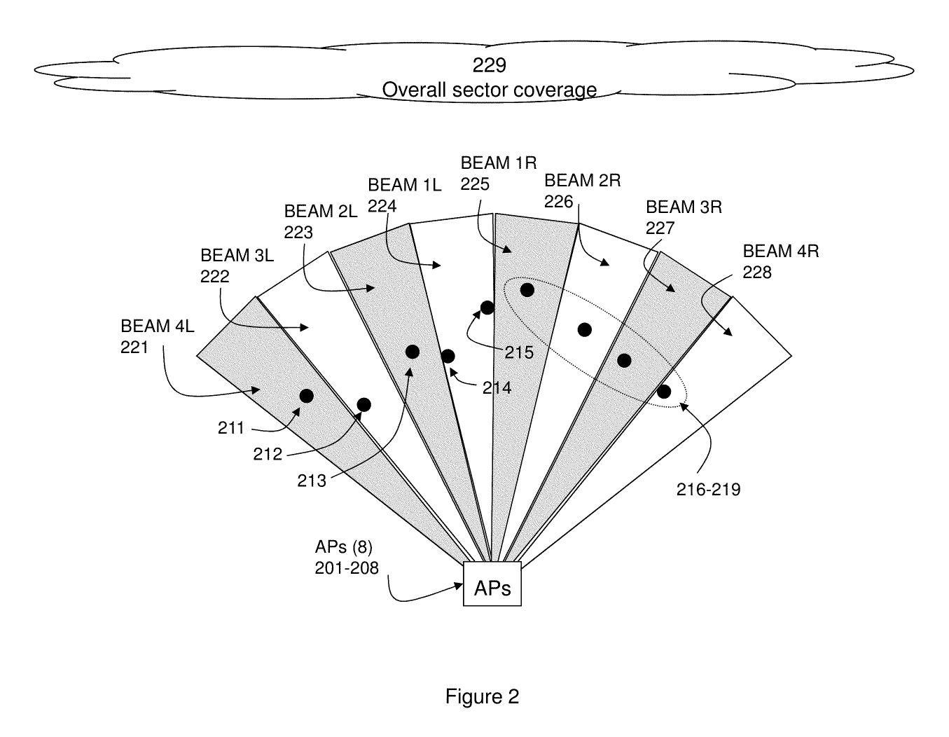

FIG. 2 shows schematically an example of a WiFi network sector with coverage area 229 subdivided into 8 (eight) subsectors 221 to 228 each served by one of beams 4L, 3L, 2L, 1L, 1R, 2R, 3R, 4R respectively. In this illustrated example there is a one to one relationship between APs 201-208 and the eight subsectors 221-228. The APs 201-208 are served by beamformers and antennas as shown in FIG. 1 whereby communications routed through APs 201 to 208 may be offered to UEs 211-219 located within the sector 229. Whilst the subsectors 221-228 are shown as non-overlapping areas for the purpose of illustration, in practice the beams 1L, 2L, 3L, 4L, 1R, 2R, 3R, 4R of the respective sectors define overlapping areas, as will be explained in more detail below. In this illustration, one of the UEs 211-219 is shown in each of the respective coverage areas of each beam 4L, 3L, 2L, 1L, 1R, 2R, 3R, 4R, except for beam 1L of subsector 224 which at the instant of FIG. 2 has two UEs 214 and 215 operating within its associated subsector 224.

The following discussion explains the use of examples of methods according to embodiments of the invention, termed “micro-steering”, to improve communications within the system, e.g. between the APs 201-208, and UEs 214 and 215. The techniques will be described for beam 1L in subsector 224 as an example but it will be appreciated that they are applicable to similar situations when other subsectors are spanned by other multiple UEs. The techniques described below are also applicable when multiple subsectors are spanned by sources of interference other than supported UEs such as UEs in other networks, cordless phones, microwave ovens and other items transmitting and/or receiving in multiple beams. Also, the techniques described herein apply for systems using MBAPs with another number of beams than eight, i.e. any number greater than one.

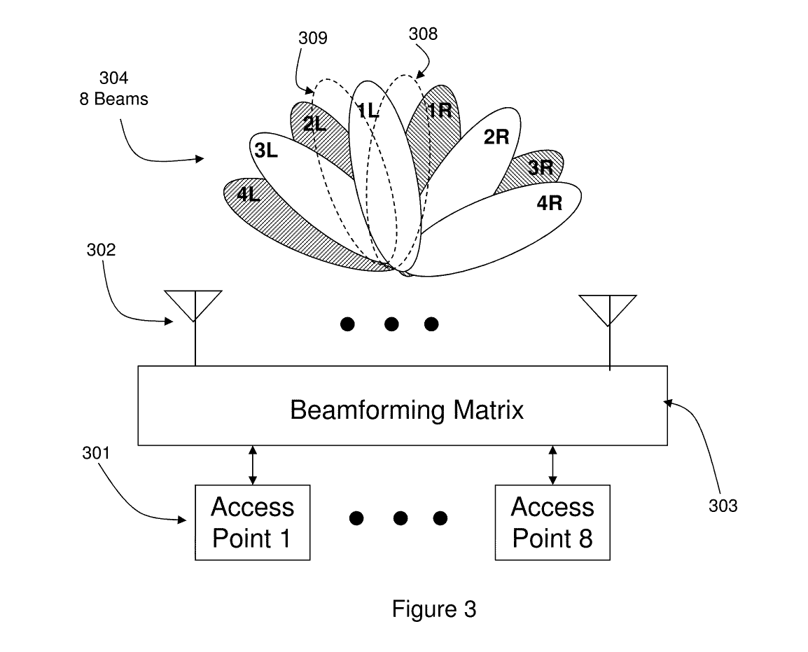

FIG. 3 shows an eight-beam multi-beam AP system. FIG. 3 illustrates how an array of antennas 302 associated with APs 301 can be controlled by beamformers in the form of a beamforming matrix 303 to create beams generally indicated by reference 304. A beamforming matrix can be calculated and implemented for example by software running on a Field-programmable gate array “FPGA” or digital signal processor “DSP”. As previously stated, adjacent beams are usually required to operate using different frequency resources to prevent interference between one subsector and an adjacent subsector. This is more fully depicted in FIG. 3 as represented by the shaded beams labeled 4L, 2L, 1R and 3R that are different from the beams labeled 3L, 1L, 2R and 4R. The shaded beams labeled 4L, 2L, 1R and 3R may for example all operate at the same frequency, or within the same frequency band or channel, which is different from that of the other beams 3L, 1L, 2R and 4R, so that no adjacent beams are operating at the same frequency, i.e. no beams of which the coverage of one overlaps the other operate at the same frequency. For the purpose of describing an embodiment of this invention, beam 1L will be used for illustration purposes. It will be assumed that signals are transmitted and received in beams 3L, 1L, 2R and 4R on frequency channel 1 and signals are transmitted and received in beams 41, 2L, 1R and 3R on frequency channel 2.

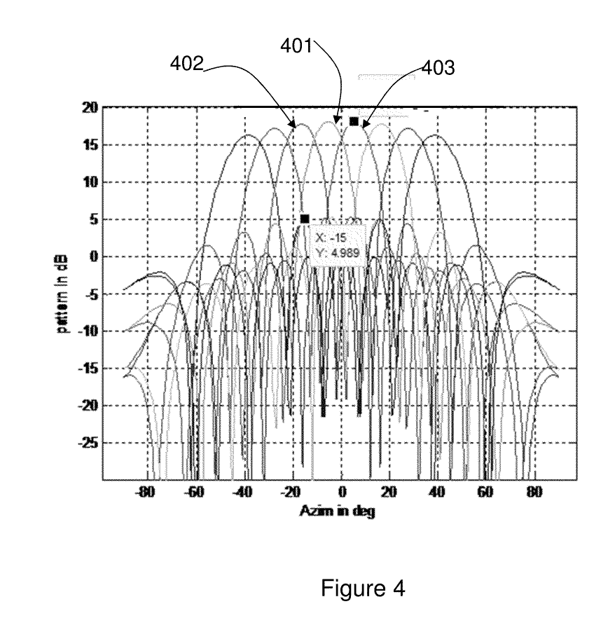

FIG. 4 presents an exemplary radiation pattern for an 8 (eight) beam MBAP. FIG. 4 exemplifies the system gain provided by each beam versus the azimuth pointing direction. Inspection of beam 401 which may for example be beam 1L of FIG. 3 further shows that only the adjacent beams 402 and 403, e.g. beams 21 and 1R of FIG. 3, provide significant coverage (gains) in some of the directions covered by beam 401, i.e., referring back to FIG. 3 only beams 2L and 1R overlap with beam 1L to a significant extent.

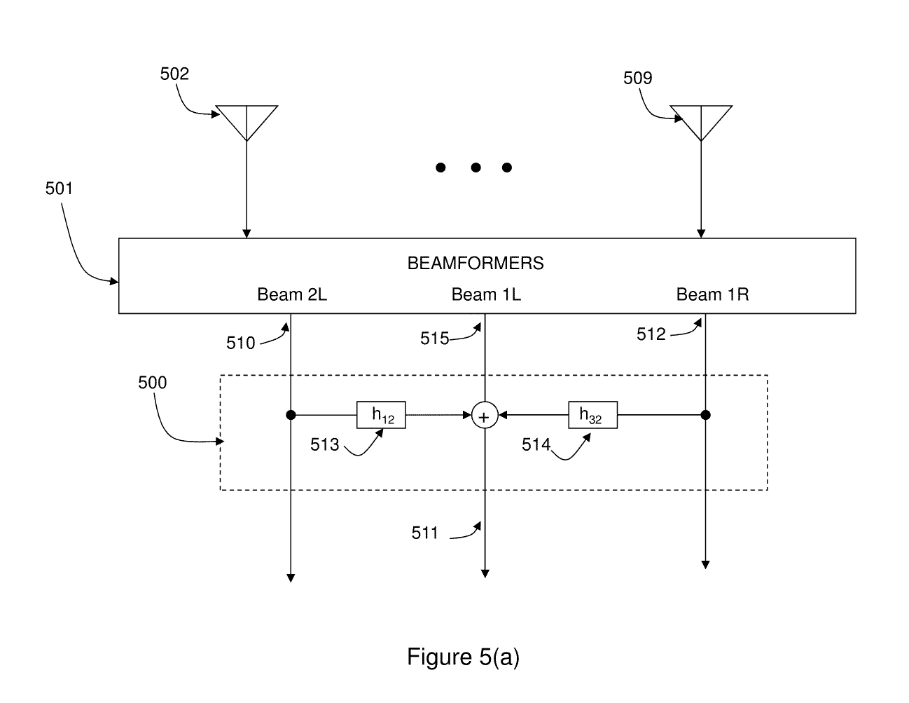

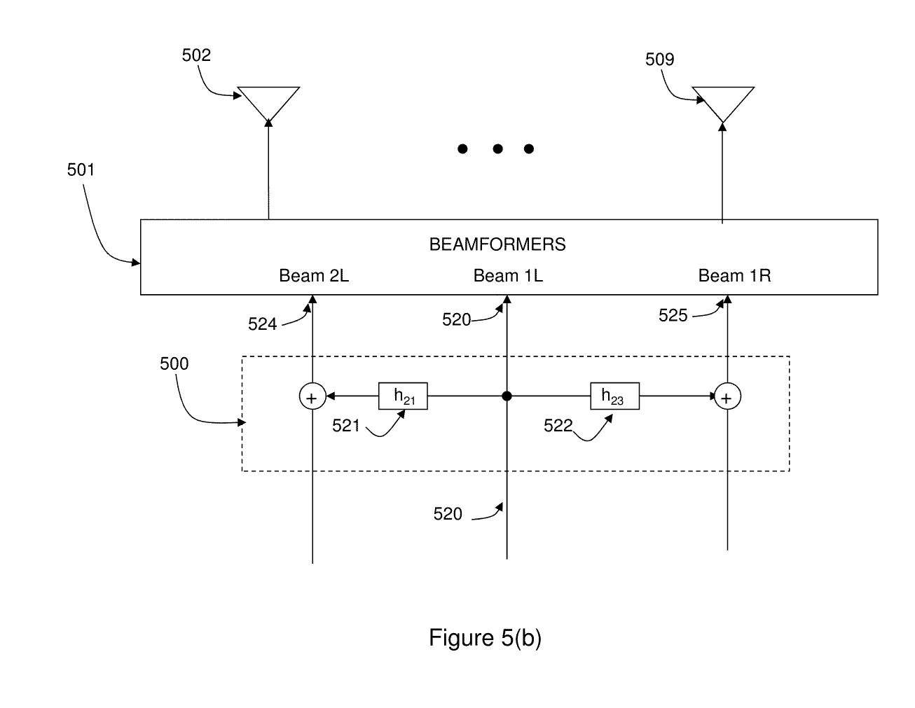

FIGS. 5(a) and 5(b) are functional diagrams for micro-steering and illustrate schematically embodiments of methods for more closely focusing coverage in the direction of a UE by coupling the signals contained in one or more adjacent beams to the beam providing the main coverage to that UE. In the example of FIG. 5(a) beams are created by antennas 502 through 509 and beamformers 501, which may be in the form of a matrix similar to the matrix of FIG. 3. In the embodiment of FIG. 5(a), the beamformers 501 are additionally controlled by a control module comprising circuitry or functionality (e.g. software) generally indicated by reference 500. It will be appreciated that the control module 500 may be replaced by multiple control modules but is referred to in the following as a single control module. Control module 500 may in practice be part of, e.g. integrated with, the beamformers 501. Also beamformers 501 may be integrated with or separate from one or more APs and other radio functionality with which they are associated. Control module 500 generates additional signals for controlling respective beams of the antennas 502-509 in a departure from the default or normal mode of operation of the antennas under the control of beamforming matrix 501. The default mode may be designed for example to ensure that the coverage of the respective beams is controlled to provide as near as possible uniform coverage over the entire sector or sectors served by one or more APs associated with the beamformers 501.

The following describes a possible departure from a default mode of operation when it is discovered that equipment is transmitting or receiving signals in two overlapping beams, such as equipment 214 and 215 shown in FIG. 2. Only three beams 2L, 1L and 1R are indicated in FIG. 5 for the purpose of this illustration, which in default mode correspond to the respective signals at 510, 511 and 512. Consider firstly the situation of a UE operating on channel 1 supported by the AP corresponding to beam 1L found to be also transmitting in the coverage region of beam 1R. In a departure from default or normal operation, beam 1R may additionally operate on channel 1 so that a sample of the signal received in beam 1R may be added to or subtracted from beam 1L. Alternatively if the UE is found to be transmitting in the coverage region of beam 2L, beam 2L may additionally operate on channel 1 so that a 5 sample of a signal received in the beam 2L may be added to or subtracted from beam 1L. This is illustrated schematically in FIG. 5 where a portion of the signal 510 received in beam 2L is subjected to a coupling function h₁₂ in module 513 before being combined with the signal 515 received in beam 1L. Similarly a portion of the signal 512 received in beam 1R is subjected to a coupling function h₃₂ in module 514 before being combined with the signal 515 received in beam 1L. The resulting combined signal 511 is processed at the AP corresponding to beam 1L.

Although the signals from modules 513 and 514 are shown as being added to the signal 515, either or both of the coupling functions h₁₂ and h₃₂ may be subtractive or null as will be explained further below. The beamformers 501, and/or the coupling functions applied in modules 513 and 514, may be implemented in either analog or digital circuitry. Each of the coupling functions h₁₂ and h₃₂ may be determined so as to adjust the amplitude or phase or both of the signals to which they are applied. For example the amplitude may be controlled through the application of one or more weighting factors which form part of each of the coupling functions h₁₂ and h₃₂.

In the example illustrated in FIG. 5(a), only signals 510 and 512 are described as being subjected to a coupling function. However, the steering of a beam towards or away from equipment may comprise applying a coupling function to the signals from both of two beams in whose coverage equipment is located. Thus for example in order to better serve UE 214 or to steer a beam away from UE 214, both of signals 510 and 511 could be subjected to adjustment of amplitude and/or phase before being combined.

The foregoing discusses only the possibility of a UE being within the coverage of two beams but it is possible for a UE to be within the coverage of more than two overlapping beams in which case the methods described with reference to FIG. 5(a) can be scaled up.

The foregoing description describes the reception of signals. The same principles are applicable to transmission and would be particularly useful for supported UEs. FIG. 5(b) corresponds to FIG. 5(a) and shows the signal paths for transmission of signals. Like parts in FIGS. 5(a) and 5(b) are indicated with like reference numerals and their descriptions are not repeated.

In FIG. 5(b) a signal 520 is intended for a UE operating on channel 1 and supported by the AP corresponding to beam 1L. The UE has already been found to be transmitting within the coverage area of beam 2L as well as within the coverage area of beam 1L. A 5 portion of the signal 520 determined by coupling function h₂₁ in module 521 is transmitted on channel 1 in beam 2L while the original signal 520, is transmitted in beam 1L. For example if the UE was a supported UE, the amplitude and phase of the signals 523 and 524 could be arranged to interfere constructively whereby to improve the signal received by the UE. Similarly if the UE was found to be transmitting within the coverage area of beam 1R, a 10 portion of the signal 520 determined by coupling function h₂₃ in module 522 could be transmitted on channel 1 in beam 1R while the original signal 520 is transmitted in beam 1L. The coupling functions determined for the received signals may be used to determine the coupling functions for the transmitted signals. The signals 524 and 525 may be added to signals on channel 1 for other equipment operating in beams 2L and 1R.

It will be appreciated from the foregoing that in some embodiments of the invention signals in respective beams are coupled either on reception or transmission or both. In embodiments of the invention the respective beams are operated such that they have a channel in common. Thus in the above examples beams 2L and/or 1R are operated on channel 1 in common with beam 1L. According to embodiments of the invention beams 2L and/or 1R 20 continue to operate on also on channel 2 so as to continue to support equipment within their coverage.

It should be noted that a system according to an embodiment of the invention may be set up so that the beams or the radios and other circuitry associated with them operate on common channels.

A possible result of this coupling method is to steer the direction of beam 1L so that it is shifted towards beam 1R to form in effect a shifted beam 308 as shown in FIG. 3 when the coupling functions h₃₂ is applied. Similarly the direction of beam 1L may be steered towards beam 2L to form a shifted beam 309 as shown in FIG. 3 when the coupling function expressed by h₁₂ is applied. As noted above, weighting factors used in the coupling functions may be determined using MRC. In one embodiment, as noted above, the method described above can be used to increase the gain offered to a supported UE. In one example, the use of coupling function h₃₂ in module 514 would suggest steering the beam 1L serving subsector 224 of FIG. 2 to better support (i.e. to increase the gain) for UE 215. In another embodiment, this method suggests reducing the impact imposed by interfering UEs by steering the offered beam further away from them. For example, it would be possible to calculate a coupling function h₁₂ applied in module 513 to point the beam 1L for subsector 224 away from UE 215 when continually providing support to UE 214. This might be desirable if the network collision avoidance was for any reason failing to avoid collisions between UEs 215 and 214. It might also be desirable if UE 215 was operating in another network. An embodiment of the invention might be used to avoid transmitting towards non-supported equipment such as a UE operating in another network, by steering the beam in which a supported UE is operating away from a non-supported UE, e.g. in the interest of being a “good neighbor”. As noted above, embodiments of the invention would be applicable to other equipment such as an emitter that was not employing collision avoidance (e.g., microwave oven or cordless phone). The pointing or shifting of a beam away from its default direction would be useful for any source of interference found to be transmitting or receiving signals in two or more overlapping beams. Such as source of interference, whether UE or otherwise, is referred to in the following as a “rogue”.

The combining of signals contained (transmitted or received) in one or more overlapping beams can be used in for example the following non-limiting scenarios:
UE with signals in two or more beams (no rogues)—steer beams to improve gain and thereby improve supported UE signal quality
UE with signals in two or more beams plus rogue in one (main) of those two beams—reduce main beam to reduce gain of rogue and/or increase adjacent beam to improve UE signal quality (e.g., SINR)
UE with signals in one (main) beam plus rogue in main and adjacent beams—steer adjacent beam to reduce signal strength of rogue in the beam supporting the UE e.g. by reducing gain of the rogue (cancel rogue signal in some embodiments
UE with signals in main plus one adjacent beam plus rogue with signals in main plus one (other) adjacent beam—steer one adjacent beam to improve UE signal quality and steer other adjacent beam to reduce interference from (cancel in some embodiments) rogue.

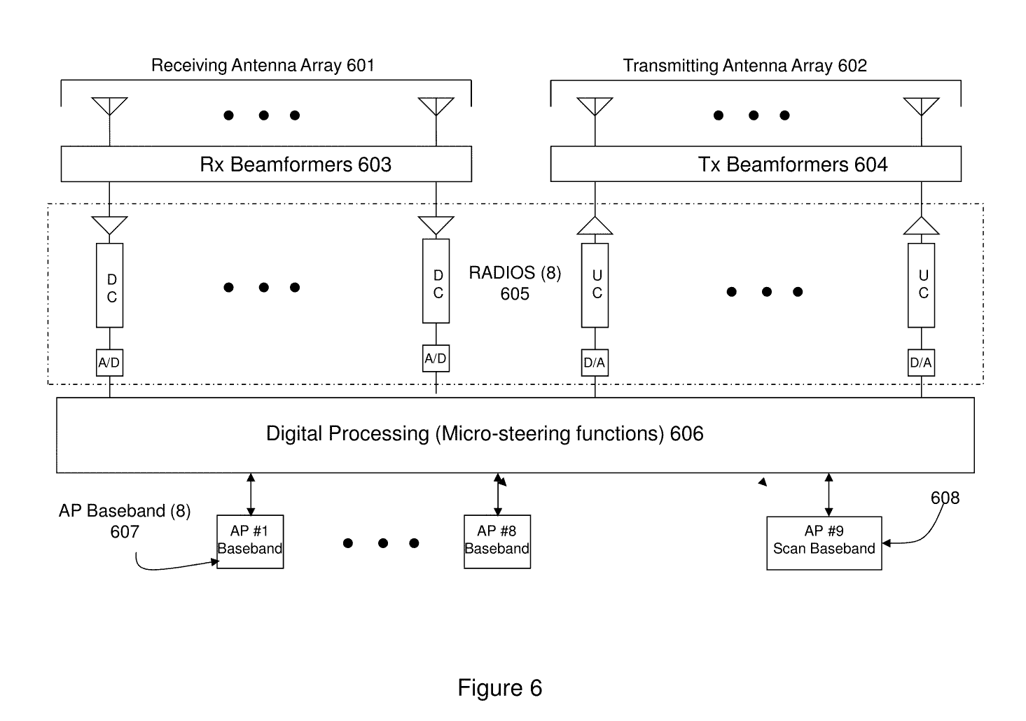

FIG. 6 is a simplified block diagram for one embodiment for beam steering. FIG. 6 shows one embodiment of a system that can implement the embodiments of methods described above. As described above, since WiFi employs a time division duplexing (TDD) protocol, it uses the same frequency resources for transmit and receive. FIG. 6 shows an arrangement with separate beamformers (e.g. in the form of matrices which may be similar to the matrix of FIG. 3) 603 and 604 for transmitting antenna array 601 and receiving antenna array 602 respectively. In other embodiments the same beamformers may be used for transmission and reception. In some embodiments the same antennas may be used for transmission and reception.

The beamformers depicted in element 604 drive the transmit antenna array 602 to create N, e.g. eight, transmit beams. For receiving, the described methods of applying the transmission functions are reversed. Thus a further defined number N e.g. eight receiving beams are created by receiving antenna array 601 which are used in conjunction with the receive beamformers 603.

For the embodiment shown in FIG. 6, the beamformers 603 and 604 are analog beamformers such as, but not limited to, Butler matrices. Signals received via beamformers 603 or transmitted via beamformers 604 are processed by radio module 605.

On the receiving side shown on the left of FIG. 6, signals are down converted in downconvertors DC and passed through analog to digital convertors A/D. The coupling functions equivalent to those of modules 513, 514, 512 and 522 of FIGS. 5(a) and 5(b), also termed micro-steering, are then performed in digital processing element 606 before being routed through the network, not shown, via APs 607. Thus it will be seen that in this embodiment the beamforming can be considered to be an additional layer of signal processing between the APs 607 and the radios and/or beamforming matrices 603 and 604.

On the transmitting side shown on the right of FIG. 6, signals from APs 607 are subjected to coupling functions in digital processing element 606 before being passed through digital to analog convertors D/A and frequency up convertors UC in radio module 605. Signals are then subjected to beamforming in beamformers 604 before being transmitted by antennas in array 602.

As noted above, in some embodiments of the invention each beam, or its respective AP, operates on one channel only. In order to determine whether any equipment is operating within the region of more than one beam, where the beams are operating on different channels, in one embodiment the different channels are scanned.

In one embodiment, shown in FIG. 6, an AP 607 is provided for each beam and in addition one or more scanning baseband APs 608, one in the illustrated example, are used during reception by a beam and its associated baseband to analyze which UE signals appear in which beam(s). Thus the signals received in each beam are routed to the scanning AP 608, for example by the digital processing element 606, as well as the dedicated beam APs 607. Measurements such as signal identification, and amplitude and phase measurement techniques such as channel estimation are carried out at the scanning AP 608. Thus the AP 608 in one embodiment may build a database of equipment operating in the respective beams. The measurements collected by the AP 608 are supplied to the digital processing element 606 and used to determine the appropriate coupling function(s) and weighting factor(s) such as shown in module 500 in FIG. 5 to be activated to improve communications. The measurements of the signals and the determination of the coupling functions and weighting factors are done using techniques known in the art. One possibility for the determination of amplitude weighting factors is maximal ratio combining “MRC” which is mentioned in the example flow below. In the case of transmission, the same coupling function(s) and weighting factor(s) chosen for receive may be applied for transmit.

It will be appreciated that instead of using a dedicated AP 608 to scan the beams, one or more of the APs 607 could be provided with additional functionality to perform the scanning, in which case signals from all of the beams could be routed by the digital processing element 606 to the AP(s) which is/are to perform the scanning. In the illustrated embodiments there are two channels to be scanned. In a practical implementation there may be any number of channels, for example fourteen according to some standards, and thus in some embodiments all available channels are scanned. Thus the radios 605 shown in FIG. 6 in some embodiments are able to support the whole frequency band, e.g. all fourteen channels.

In FIG. 6 the APs 607 and 608, the digital signal processing 606 and the beamformers 603 and 604 may be implemented in hardware or software, e.g. software running on a general purpose computer. It will be appreciated that the beamformers and the APs may also include digital signal processors. Although these are shown as separate elements or components in FIG. 6, any of them can be combined in a single module. In the case of combining the beamformers with the digital signal processing 606, this could be achieved for example by positioning the radios in direct communication with the antennas 601, 602, and performing the beamforming prior to A/D conversion.

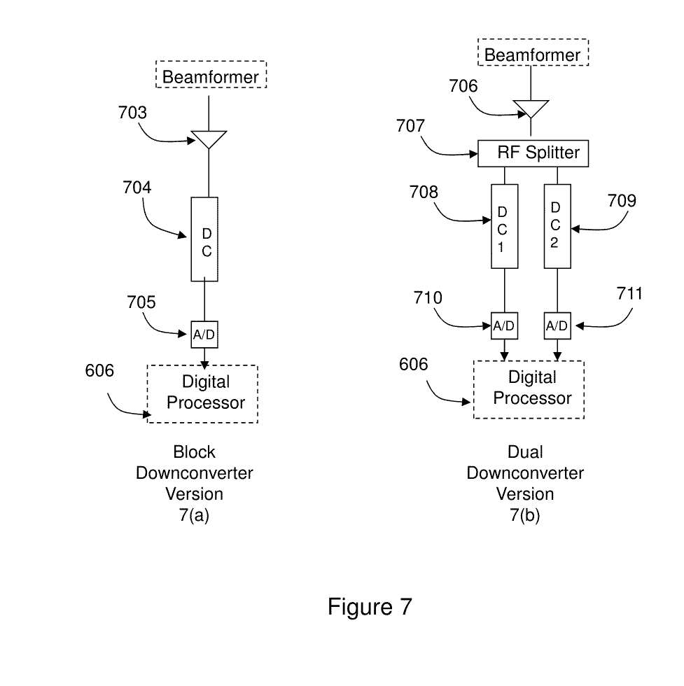

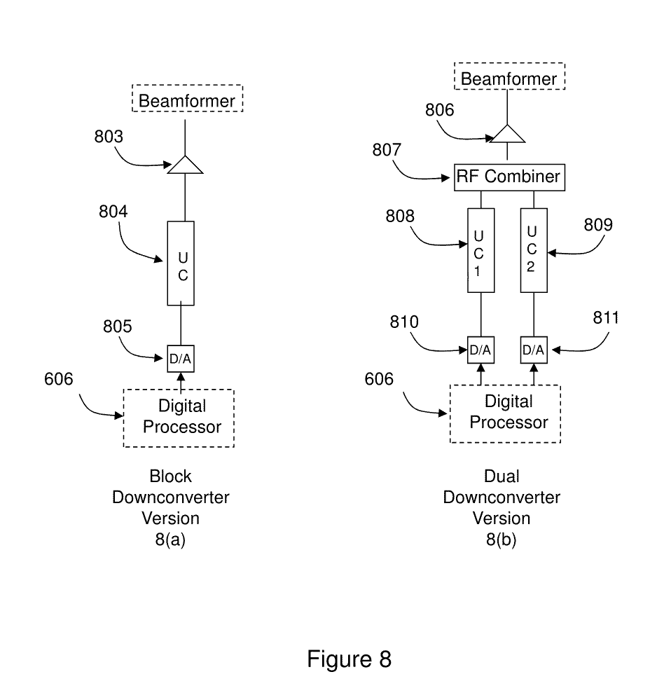

As shown in FIG. 2 and FIG. 3, adjacent beams are normally operated on non-interfering channels. In the embodiments of this invention described here adjacent beams are able to operate (receive and transmit) also on the same communications resources, e.g. frequencies. It is known to use bandpass filtering in the downconverters and upconverters to prevent interfering operation. Now it may be desired to encourage interfering operation. FIG. 7 and FIG. 8 show two approaches to remedy this situation for receiving and transmitting, respectively.

FIG. 7 shows two simplified block diagrams for two embodiments of radio downconverter assembly that might be used as the transmitting radios 605 shown in FIG. 6. One downconverter assembly of the kind shown in FIG. 7(a) or FIG. 7(b) may be provided for each beam. FIG. 8 shows two simplified block diagrams for two embodiments of radio upconverter assembly that might be used for each beam as the receiving radios 605 shown in FIG. 6. One upconverter assembly kind shown in FIG. 8(a) or FIG. 8(b) may be provided for each beam. The first configurations in FIGS. 7(a) and 8(a) illustrate the use of single block downconverters 704 and upconverters 804 for transmitting and receiving respectively at the antennas 703 and 803. Such block converters 704 and 804 may cover the complete frequency band to be potentially used (e.g., roughly 2.4 to 2.5 GHz for the 2.4 GHz band, which could include fourteen channels). Analog to digital “A/D” converters 705 and digital to analog “D/A” converters 805 in this embodiment support each frequency band (2.4 GHz and 5 GHz) in total. A/D convertors 705 supply signals from digital processor such as processor 606 of FIG. 6. D/A convertors receive signals from digital processor 606 of FIG. 6. Linearity and spectral purity requirements (e.g., adjacent channel leakage ratio (ACLR)) may make this a less desirable but nevertheless possible implementation when handling multiple signals simultaneously.

Alternatively, FIGS. 7(b) and 8(b) show configurations in which separate down converting and up converting elements are contained in each channel. FIG. 7(b) shows that signals received by antenna 706 are split by RF splitter 706 before being handled by separate downconvertors 708 and 709, converted by respective A/D/convertors 710 and 711 and processed in digital processor such as processor 606 of FIG. 6. Conversely signals received by antenna 806 in FIG. 8(a) are first combined in RF combiner 807 before being passed to upconverters 808 and 809 and from there to digital processor such as processor 606 of FIG. 6. This embodiment suggests the use of less stringent requirements imposed on the parameters in the downconverters 708 and 709 and upconverters 808 and 809 as well as the analog to digital converters 710 and 711 and digital to analog converters 810 and 811 because each one is only required to support one channel rather than the whole frequency band.

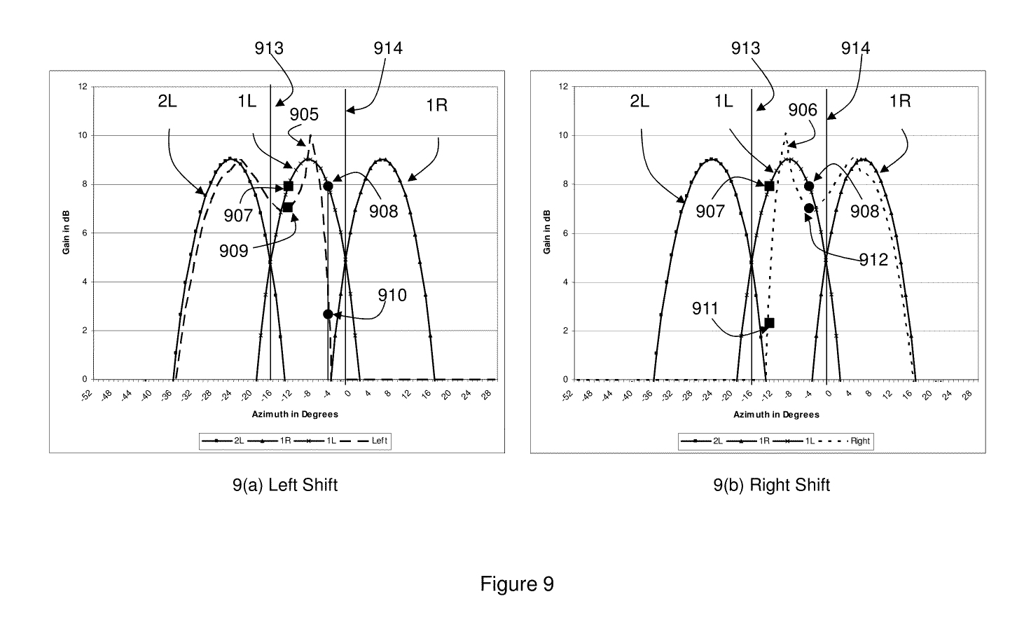

FIG. 9 presents radiation pattern examples of the beam shapes before and after micro-steering. In FIGS. 9(a) and 9(b), adjacent beams 2L, 1L, and 1R are depicted as typical from an eight beam Butler matrix beamformer using isotropic antenna elements. The figure suggests a system with coverage offered by two UEs in the directions of beam 1L. For this example, one UE referred to as the “left” UE is assumed to be offered in the direction to the left of beam 1L and the closer of the two to the directions covered by beam space of beam 2L. Prior to micro-steering it occupies position 907 on the gain curve. Conversely, the other UE referred to as the “right” UE is to the right of the coverage of beam 1L and the closer of the two to beam 1R. Prior to micro-steering it occupies position 908 on the gain curve. Lines 913 and 914 show boundaries contained with beam spaces 1L and within beamspaces 2L and 1R, respectively, along which a UE could in principle be served equally well by either of two APs. As a matter of reference, directions 913 and 914 show the boresight directions normal to the linear array that mark the boundaries of beam 1L.

FIGS. 9(a) and 9(b) show two examples, one with a shift towards 2L and one with a 25 shift towards 1R.

FIG. 9(a) shows an exemplary (dashed) pattern 905 that results when the beams contained in 2L and 1L are summed equally by adjusting the coupling amplitude and phase of the signal from beam 2L with respect to the phase of the signal from beam 1L using function h₁₂ in module 513 of FIG. 5(a) such that the signals in the direction of the left UE are enhanced. At the same time signals in the direction of the right UE are decreased by adjusting the phase of the signal from beam 1R with respect to the phase of the signal from beam 1L using the coupling function contained in function h₃₂ in module 514 of FIG. 5(a). The scaled radiation pattern 905 shown in 900 shows results of approximately 5 dB relative reduction of the gain presented to the right UE now at to position 910 versus the gain offered to the left UE now at position 909, thereby improving the overall quality of the communication channel available to the left UE.

It should be noted that when serving the left UE with a transmission offering, the application of the same weighting functions should be conferred to the transmitted signals as for received signals as detailed above. Doing so will reduce the interference impairments presented to non-served UEs (e.g. 908 in the above example) by the radiated signal.

The radiation pattern shown by the dashed line 906 in FIG. 9(b) suggests similar results conveyed in measured performances described above by reversing the coupling functions. Thus as shown in FIG. 9(b) the scaling or steering towards beam 1R results in a large drop in gain for the left UE from position 907 to 911 and a smaller drop for the right UE from position 908 to 912. The large drop shown on the left results in an overall improvement in the quality of the communication channel available to the UE on the right as a result of the reduction in interference from the UE to the left, even though the gain is reduced. The above descriptions for beam “1L” using beams “2L” and “1R” are further applicable for all beams in the system with the exception that the outer beams (4L and 4R of FIG. 2) have only one adjacent beam available in concert using this method.

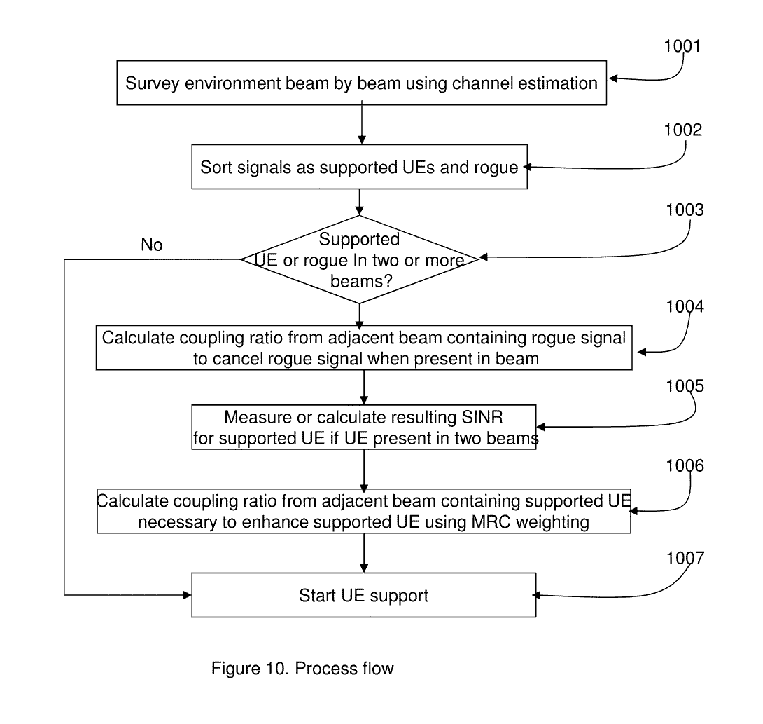

FIG. 10 outlines an example of a high level process flow that may be used to implement an embodiment of a method according to the invention. An initial survey of the signal environment is performed beam by beam at 1001 using e.g. the channel estimation capabilities of scanning AP 608 of FIG. 6. For each signal received over all operational channels a classification is performed at 1002 to determine if it is from a desired (supported) UE or an undesirable signal (e.g. another (unsupported) UE or in-band interfering rogue emissions) and to determine its signal characteristics (i.e. signal amplitude and phase received in each beam). Next a determination is made at 1003 as to whether either a supported UE or a rogue signal is present in two or more beams, which may be determined e.g. by determining whether the UE or rogue signal source is transmitting or receiving signals in the two or more beams. If negative, UE support for any supported UE identified at 1002 commences at 1007. If decision 1003 is positive, at this stage it should also be ascertained whether an interfering signal and supported UE are received in the same set of beams since in general, coupling from adjacent beams will not produce improvement in this case. If decision 1003 is positive and if an interfering signal and supported UE are received in different beams the flow continues to 1004.

The remainder of the flow is described with reference to a UE or rogue signal being present in two beams only using the example of FIG. 9 and assuming that the rogue signal is in beams 1R and 1L and the supported UE is in beams 1L and 2L. However it will be appreciated that it can be scaled up for a three dimensional situation. Thus at 1004, if a rogue signal was found to be present in two beams at 1002, e.g. 1L and 1R, then a coupling ratio or weighting factor for coupling the beam 1R containing the rogue signal and not the UE (the adjacent beam) to the beam 1L containing the rogue signal and the UE (the main beam) is calculated. This should be determined so as to cancel the rogue signal when present in the main beam 1L. Therefore in one embodiment the amplitudes of the two signals should be equal and they should be out of phase. The coupling ratio is then applied to the adjacent beam 1R which is added to the main beam 1L to cancel the rogue signal.

If a UE was found to be present in two beams 2L and 1L at decision 1003, it may be possible to improve the channel quality offered to the UE whether or not a rogue signal was found to be present on one or two beams.

At 1005, if a UE was found to be present in two beams, the signal to noise plus interference ratio (SINR) for the supported UE (after any cancellation or reduction of interference achieved in 1004) in the two beams is determined. Then at 1006, based on the SINRs determined at 1005, weighting, e.g. MRC weighting, may be used to calculate the coupling ratio for the beam 2L containing the UE but not the rogue signal (the “adjacent” beam for the UE).

At 1007 support for the UE is commenced using any coupling ratios determined at 1004 and 1006. The phase of one or both signals may be adjusted so that they are in phase.

In an optional alternative method a decision may be made e.g. prior to 1004, whether there will be any improvement for the UE by coupling signals from adjacent beams. Should the assessment determine there is no improvement using the signals from the adjacent beams, the UE may be supported with no further action. If it is determined there is a potential improvement in UE signal quality, then the required phase and amplitude weighting may be computed to best cancel the undesirable signal(s). Additionally a weighting factor may be computed to enhance the signal from the supported UE. It will be appreciated that MRC is just one possible embodiment of a method for determining how the signals in adjacent beams may be coupled. MRC requires knowledge of the SINRs in the beams. Another possibility for enhancement would be to determine a ratio for the signal in the adjacent beam such that the respective signals are equal before combining. Some improvement may be achieved by simply adding the signals in adjacent beams for a supported UE appearing in both beams after adjusting the phase to be additive. Other suitable methods will be apparent to those skilled in the art.

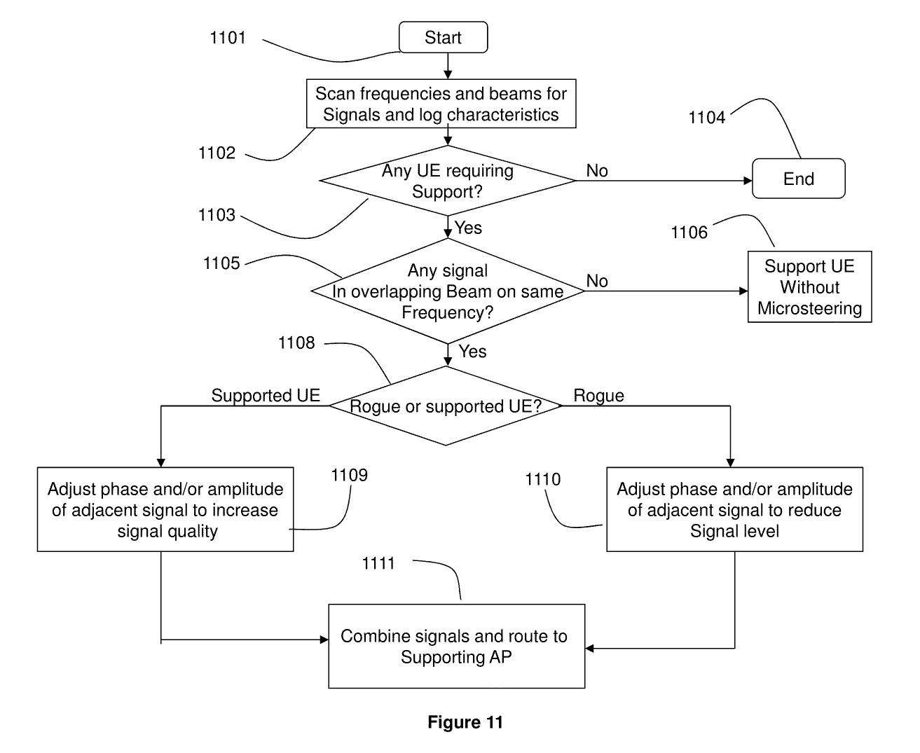

Some more specific examples of process flows that may be used to implement embodiments of the invention will now be described with reference to FIGS. 11-13. These examples are described with reference to scenarios in which an item of equipment is found to be transmitting in the region of two beams but it will be appreciated as mentioned above that these example method embodiments may be scaled up for equipment found to be transmitting in more than two beams.

The flow of FIG. 11 commences with a start operation 1101, after which all frequency resources used by the beams in the MBAP system, e.g. the system shown in FIG. 6, are scanned at operation 1102 to determine whether there is any UE requiring support. This may be done using a scanning AP as discussed above in connection with FIG. 9. At this stage the characteristics of signals may be logged or recorded. A determination is made at decision 1103 whether there is any UE requiring support. If there is no UE requiring support the process will end at 1104.

If there is a UE requiring support, the next operation 1105 is to identify whether there is any equipment, supported or otherwise, that is transmitting signals in the beam assigned to the UE found at 1105 and an overlapping or adjacent beam on the same frequency. If that is the case micro-steering as described above might be useful. If there is no such equipment, then any equipment requiring support is supported without micro-steering e.g. according to any method known in the art, at operation 1106.

If equipment is found to be operating, e.g. transmitting in two beams at decision 1105, then in order to benefit from micro-steering one of the beams may be configured to use the same frequency resource as the other of the two beams in which the equipment is found to be operating. According to embodiments of the invention the beams continuously operate on both channels but the routing and signal processing at the APs may use the signals on selected channels for effecting normal support or cancelling rogue signals or augmenting service to supported equipment. Thus beam 2L in FIG. 3 may operate on channel 1 in common with beam 1L, whilst continuing to operate on channel 2. Then both beams 2L and 1L are able to receive signals from the equipment identified at 1105. The continuing flow may depend on whether the equipment identified at 1105 is a supported UE or equipment that is not supported by the communications network. Therefore a decision may be made as to which type of equipment has been identified at 1108.

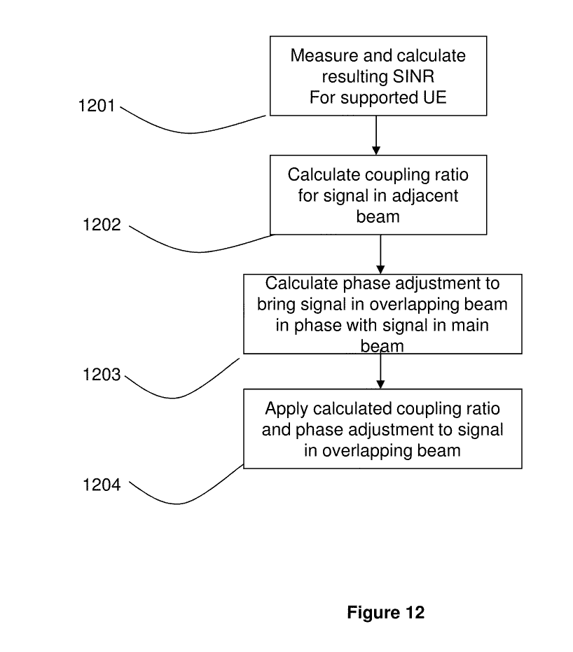

If the equipment is a supported UE, micro-steering may be used to improve the signal quality of that UE by coupling signals received in the two beams at operation 1109. This coupling, in one embodiment, may comprise adjusting the phase or amplitude or both of the signal in the adjacent or overlapping beam, e.g. the beam that is not assigned to the UE. This coupling, in another embodiment, may comprise adjusting the amplitude and/or phase of one or both of the signals in the respective beams. According to embodiments of the invention this coupling is designed to increase signal quality. In the flow of FIG. 11 it is followed by combining and routing the signals in both beams to the AP supporting the UE at operation 1111, for example the AP corresponding to the main beam, e.g. 1L in the example of FIG. 3. One possible manner of carrying out the adjustment is described in more detail below with reference to FIG. 12.

If the equipment is a rogue, e.g. a UE supported by a different network or some other source of interference, micro-steering may be used to improve the signal quality of a supported UE identified at 1103 by coupling signals received in the two beams. However in this operation aim is not to increase signal quality but to reduce signal strength, so as to reduce any interference caused by the identified equipment. In the flow of FIG. 11 this coupling comprises adjusting the phase or amplitude or both of the signal in the adjacent or overlapping beam, e.g. the beam that is not assigned to the UE. This coupling in another embodiment comprises adjusting the amplitude and/or phase of the signals in one or both beams at operation 1110. The coupling is followed by combining and routing signals in both beams to the AP supporting the UE at operation 1111.

In one embodiment as noted above the amplitude and phase are determined at operation 1110 to cancel the signal from the rogue equipment. Thus the signals are adjusted to be in phase and equal in amplitude. In one embodiment this is done by adjustment of the signal in the adjacent beam only. In another embodiment it might be desirable to adjust the signal in the main beam only or both the adjacent beam and the main beam.

The foregoing assumes that only one item of equipment is identified at 1105. If multiple equipment items are identified at 1105, operations 1108 to 1111 are repeated as appropriate for each item that is operating in two beams. The operations may be conducted one after the other or in parallel. In one embodiment the overall flow may result in operations 1109 and 1110 being conducted simultaneously.

One possible scenario is a UE operating in a main and an adjacent beam, e.g. 1L and 2L and a rogue operating in the same main beam and a different adjacent beam, e.g. 1L and 1R. In that case it may be desirable to conduct one of operations 1109 and 1110 after the other since one will have an effect on the other. For example if the rogue is cancelled as a result of operation 1110 this will have an effect on the SINR of the supported UE which may be used in operation 1109 as will be explained further below with reference to FIG. 12.

Another possible scenario is multiple rogues being discovered operating in the same set of beams. It may not be possible to cancel one without increasing the interference from the other. If that is the case operation 1110 will be conducted in order to reduce the collective strength or power of the rogue signals.

Other scenario s may occur to the person skilled in the art.

Some possible methods for carrying out the amplitude or phase adjustment shown in operation 1109 of the embodiment shown in FIG. 11 will now be described with FIG. 12. The first operation 1201 shown in FIG. 12 is to measure, calculate or otherwise determine the SINR for equipment determined to be a supported UE at operation 1108. This is an optional procedure and may not be necessary depending on how the other operations of FIG. 12 are performed. The second operation 1202 shown in FIG. 12 is the calculation of a coupling ratio for the signal in the adjacent beam to be added to or coupled to the signal in the main beam. This coupling ratio indicates the desired relative amplitudes of the signals in the main beam and the adjacent beam. In one embodiment this may be done using MRC as discussed above in connection with FIG. 10. In one embodiment, for example when there is a large amount of interference in the main beam, e.g. from equipment that is not supported, it may be appropriate for the amplitude of the signal in the adjacent beam to be larger than the amplitude of the signal in the main beam. Thus the coupling ratio may imply that it is desirable to reduce the amplitude of the signal in the main beam, in which case this may be done. This could be achieved for example using additional functionality in the control module 500 in signal path 515 of FIG. 5. Thus at operation 1202 according to some embodiments of the invention a coupling ratio is calculated for the adjacent beam, e.g. a beam other than the beam assigned to the UE, and/or a beam that has not been assigned to the UE.

At operation 1203 a calculation is done to determine a phase adjustment. In one embodiment this is the phase adjustment necessary to bring the signal in the adjacent or overlapping beam into phase with the signal in the main beam. At operation 1204 the coupling ratio and phase adjustment determined at operations 1202 and 1203 are applied to the signals in the main and/or adjacent or overlapping beam. The flow then proceeds according to operation 1111 of FIG. 11 where the adjusted signals are routed to the AP supporting the UE.

It will be clear from the above that in one embodiment only the signals in the adjacent beam, i.e. the beam corresponding to an AP that is not currently supporting a target UE, are adjusted in terms of amplitude and phase and added to (constructively or destructively) the signal in the main beam. In other embodiments it may be advantageous also to adjust the signals in the main beam in terms of amplitude and/or phase.

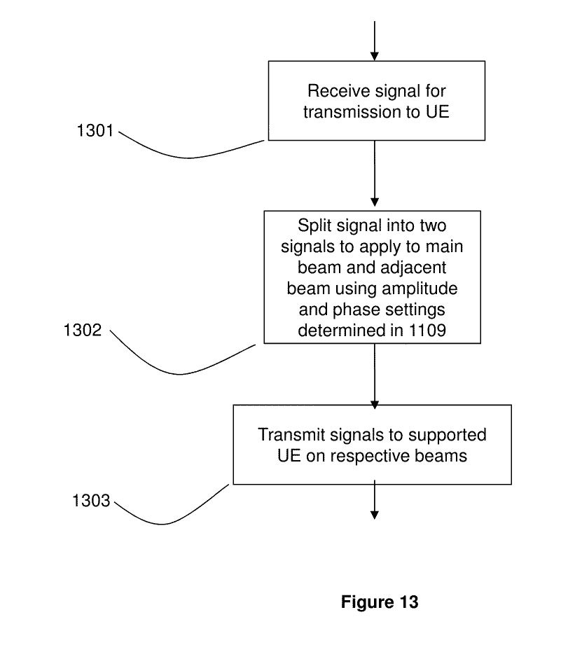

The foregoing discusses the reception of signals in the beams and their routing to respective Aps. The same micro-steering techniques may be used in the transmission of signals to equipment operating in the beam sub-sectors. This may be particularly beneficial for supported equipment. FIG. 13 shows a process flow that may be used in an embodiment of the invention for the transmission of signals. The operations shown in FIG. 13 may be used in addition to (e.g. in parallel with) or instead of the operations 1109 and 1111 shown in FIG. 11.

FIG. 13 shows operations that might be carried out for example in digital signal processor 606 of FIG. 6. Thus the first operation 1301 may be to receive, e.g. from an AP, a signal intended for transmission to a supported UE operating in the beam corresponding to that AP as well as an adjacent beam. This signal in this embodiment is then separated into two signals to be transmitted in two beams, main and adjacent, at operation 1302. The relative phases and amplitudes of the signals produced at operation 1302 may be those determined in operation 1109 of FIG. 11 which may be according to any of the flows described with reference to FIG. 12. Thus operation 1302 of FIG. 13 may commence after the determination of coupling ratio and phase adjustment, for example using operations 1202 and 1203 described above with reference to FIG. 12. The resulting signals are then transmitted to the UE at operation 1303 over the respective beams, e.g. main and adjacent beams. For this operation the two beams, or the APs for the two beams may operate on a common channel. For example the adjacent beam may be configured to transmit on the same channel as the main beam or the beams may operate on all channels continuously and the APs for the respective beams may be configured to operate on the same channel. The adjacent beam may at the same time transmit on a different channel in order to support equipment operating in the adjacent beam by the AP corresponding to the adjacent beam.

It will be appreciated from the foregoing that embodiments of the invention may be used to generate signals for transmission over respective beams to equipment where they are coupled, or to couple signals received in respective beams. The aim of the coupling depends on whether the equipment is a supported UE or a rogue.

As will be appreciated by one skilled in the art, aspects of the present invention may be embodied as a system, method or an apparatus. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system”. Thus an embodiment of the invention may take the form of a computer readable medium comprising instructions which when executed on one or more processors in a computing system cause the system to implement any of the methods described above.

The aforementioned flowchart and block diagrams illustrate the architecture, functionality, and operation of possible implementations of systems and methods according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

In the above description, an embodiment is an example or implementation of the inventions. The various appearances of “one embodiment,” “an embodiment” or “some embodiments” do not necessarily all refer to the same embodiments.

Although various features of the invention may be described in the context of a single embodiment, the features may also be provided separately or in any suitable combination. Conversely, although the invention may be described herein in the context of separate embodiments for clarity, the invention may also be implemented in a single embodiment.

Reference in the specification to “some embodiments”, “an embodiment”, “one embodiment” or “other embodiments” means that a particular feature, structure, or characteristic described in connection with the embodiments is included in at least some embodiments, but not necessarily all embodiments, of the inventions.

It is to be understood that the phraseology and terminology employed herein is not to be construed as limiting and are for descriptive purpose only.

The principles and uses of the teachings of the present invention may be better understood with reference to the accompanying description, figures and examples.

It is to be understood that the details set forth herein do not construe a limitation to an application of the invention.

Furthermore, it is to be understood that the invention can be carried out or practiced in various ways and that the invention can be implemented in embodiments other than the ones outlined in the description above.

It is to be understood that the terms “including”, “comprising”, “consisting” and grammatical variants thereof do not preclude the addition of one or more components, features, steps, or integers or groups thereof and that the terms are to be construed as specifying components, features, steps or integers.

If the specification or claims refer to “an additional” element, that does not preclude there being more than one of the additional element.

It is to be understood that where the claims or specification refer to “a” or “an” element, such reference is not be construed that there is only one of that element.

It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

The term “method” may refer to manners, means, techniques and procedures for accomplishing a given task including, but not limited to, those manners, means, techniques and procedures either known to, or readily developed from known manners, means, techniques and procedures by practitioners of the art to which the invention belongs.

The descriptions, examples, methods and materials presented in the claims and the specification are not to be construed as limiting but rather as illustrative only.

Meanings of technical and scientific terms used herein are to be commonly understood as by one of ordinary skill in the art to which the invention belongs, unless otherwise defined.

The present invention may be implemented in the testing or practice with methods and materials equivalent or similar to those described herein.

While the invention has been described with respect to a limited number of embodiments, these should not be construed as limitations on the scope of the invention, but rather as exemplifications of some embodiments. Other possible variations, modifications, and applications are also within the scope of the invention. Accordingly, the scope of the invention should not be limited by what has thus far been described, but by the appended claims and their legal equivalents.

1. A method of operating two or more access points in a wireless communications network wherein a system of two or more access points are supported by an antenna array that provides multiple beams having overlapping coverage, the method comprising:
identifying equipment which is transmitting or receiving signals in at least two overlapping beams of the multiple beams having overlapping coverage;
using a common frequency resource in said at least two beams;
modifying a beam width of at least one of the overlapping beams by coupling signals received from said identified equipment or generating signals for transmission to identified equipment in said at least two overlapping beams, thereby resulting in at least one of the following:
increasing signal quality for identified equipment that is supported by the communications network; and
reducing signal strength for identified equipment that is not supported by the communications network.

2. The method of claim 1 wherein said coupling or generating comprises adjusting one or both of amplitude and phase of the signal voltage received from or to be coupled at the equipment.

3. The method of claim 2 wherein the adjusting comprises determining a coupling function including one or more weighting factors for amplitude for one of the signal voltages from at least one of the at least two beams to be coupled to the signal voltages of another of the at least two beams.

4. The method of claim 2 wherein the coupling is to increase signal quality for identified equipment that is supported by the communications network and the one or more weighting factors are determined using maximal ratio combining.

5. The method of claim 1 in which said coupling is performed to increase signal quality for identified equipment and further comprising:
using channel estimation to determine one or both of:
one or more weighting factors for the coupling of the signals in the at least two beams; and
the relative phases of signals to be coupled in the at least two beams.

6. The method of claim 5 in which said channel estimation is performed on received signals in said at least two overlapping beams and further comprising using one or both of weighting factors and relative phases to determine one or both of relative amplitudes and relative phases of signals for transmission to identified equipment.

7. The method of claim 1, wherein said identifying identifies:
equipment that is supported by the network transmitting or receiving in a main beam and at least one overlapping adjacent beam of said multiple beams having overlapping coverage, and
equipment that is not supported by the network transmitting or receiving in the main beam and at least one different overlapping adjacent beam of said multiple beams having overlapping coverage; and
wherein the coupling comprises coupling signals from said supported equipment in the adjacent beam(s) and the main beam and simultaneously coupling signals from equipment that is not supported in the different adjacent beam(s) and the main beam.

8. The method of claim 7 comprising:
determining one or more weighting factors for signals to be coupled at the not supported equipment; and then
determining one or more weighting factors for signals to be coupled at the supported equipment.

9. The method of claim 8 wherein the one or more weighting factors for signals to be coupled at the supported equipment are determined using maximal ratio combining.

10. The method of claim 1 comprising scanning frequency resources used by the beams having overlapping coverage to analyze which equipment signals appear in which beam.

11. The method of claim 1 comprising determining whether identified equipment is user equipment “UE” supported by the communications network.

12. The method of claim 1 wherein said identifying identifies a UE supported by the communications network and further comprising:
identifying equipment that is not supported by the communications network that is transmitting or receiving signals on a subset of the at least two beams having overlapping coverage,
wherein said coupling comprises reducing the power of one or more of the beams in the subset.

13. The method of claim 1 wherein the coupling for equipment that is not supported by the communications network comprises adjusting one or both of the amplitude and phase of signals in one of the at least two beams to cancel the signal from the equipment in another of the at least two beams.

14. A system for use in a wireless communications network, the system comprising:
two or more wireless access points associated with multiple beams having overlapping coverage;
two or more beamformers configured to control an antenna array to create the multiple beams;
one or more processors configured to control one or both of amplitude and phase of signals applied by the access points to the beamformers or applied from the beamformers to the access points, the system being configured to:
operate at least some of the beams having overlapping coverage to use at least a common frequency resource;
modify a beam width of at least one of the overlapping beams by coupling signals received from or generate signals to be transmitted to equipment in at least two overlapping beams using a common frequency resource, thereby resulting in one or both of:
increasing signal quality for equipment that is supported by the communications network; and
reducing signal strength for equipment that is not supported by the communications network.

15. The system of claim 14 in which the beams are fixed beams.

16. The system of claim 14 comprising a scanning access point configured to scan the multiple beams to determine which equipment is operating in which beam.

17. The system of claim 14 in which the beams operate on at least two different frequency channels comprising a single block radio frequency upconverter for each antenna of the antenna array.

18. The system of claim 14 in which the beams operate on at least two different frequency channels comprising a single block radio frequency downconverter for each antenna.

19. The system of claim 14 in which the beams operate on at least two different frequency channels comprising separate radio frequency upconverters for each antenna of the antenna array for each channel.

20. The system of claim 14 in which the beams operate on at least two different frequency channels comprising separate radio frequency downconverters for each antenna for each channel.
